(19) United States
(12) Patent Application Publication
(10) Pub. No.: US 2014/0133781 A1
(43) Pub. Date: May 15, 2014

(54) IMAGE PROCESSING DEVICE AND IMAGE PROCESSING METHOD

(71) Applicant: Sony Corporation, Tokyo (JP)

(72) Inventors: Takao Inoue, Kanagawa (JP); Hiroyuki Suzuki, Tokyo (JP); Sayaka Shida, Tokyo (JP)

(73) Assignee: Sony Corporation, Tokyo (JP)

(21) Appl. No.: 14/072,166

(22) Filed: Nov. 5, 2013

(30) Foreign Application Priority Data
Nov. 12, 2012 (JP) 2012-248153

(51) Int. Cl. G06K 9/36

(52) U.S. Cl. CPC G06K 9/36
USPC 382/307

(57) ABSTRACT

There is provided an image processing device including functional blocks each including an input unit, an output unit, and at least one image processing circuit that performs a predetermined image process; first input switching units each of which is associated with the input unit of each functional block one-to-one, selects one piece of image data including image data output from the output unit of another functional block, and outputs the selected image data to the associated functional block; a second input switching unit which selects at least one piece of image data from input image data and outputs the selected image data to any of the first input switching units; an output switching unit which selects and outputs at least one piece of image data from the image data output from the output unit of each functional block; and a selection control unit which controls switching of the above selection.

### CROSS REFERENCE TO RELATED APPLICATIONS

This application claims the benefit of Japanese Priority Patent Application JP 2012-248153 filed Nov. 12, 2012, the entire contents of which are incorporated herein by reference.

### BACKGROUND

The present disclosure relates to an image processing device and an image processing method in which a plurality of different image processes should be performed.

Imaging devices which photograph moving images and reproduction devices which reproduce moving images perform a process of converting resolution of image data according to resolution required in display devices and recording devices which are output destinations of the image data. In addition, depending on objectives, a process of converting colorimetry (a color space) of image signals, or a process of reinforcing image signals is also performed. In addition, it is necessary to perform such image processes in a predetermined frame cycle such as one frame in terms of an imaging frame rate, or the like. In an imaging device, for example, it is necessary to perform a process of converting resolution of an image signal into resolution appropriate for a view finder display and into resolution appropriate for a monitor such as an LCD (Liquid Crystal Display) in one frame cycle of an imaging frame rate.

In image processes performed hitherto, functional blocks which include one or more of image processing circuits have been provided to correspond to each image process when a plurality of image processes are performed at a uniform frame rate. When it is necessary to generate four images which have undergone different image processes in one frame, for example, four functional blocks which perform different image processes are provided. Each of the functional blocks is configured to perform an image process within less than one frame, the four functional blocks perform the image processes in parallel, and as a result, four images which have undergone the different image processes can be obtained within one frame cycle.

However, when there are a large number of kinds of image processes which should be performed within a predetermined frame cycle, it is also necessary to increase the number of functional blocks by the number of the kinds of the image processes, and accordingly, the circuit scale increases. Japanese Unexamined Patent Application Publication No. 2001-238219 discloses a technology of using a decoder shared during normal-order reproduction and inverse-order reproduction of MPEG (Moving Picture Experts Group) video streams as a technology of reducing a circuit scale.

### SUMMARY

As disclosed in Japanese Unexamined Patent Application Publication No. 2001-238219, if a circuit is shared for image processes in which the same process is performed, the circuit scale can be reduced accordingly. However, in the resolution conversion process described above, for example, there are cases in which the resolution conversion process should be performed a plurality of times within a predetermined frame cycle. There is a situation in which, for example, both of a process of converting HD (High Definition) into SD (Standard Definition) and a process of converting 4K (4096×2160 pixels or 3840×2160 pixels) into 2K (2048×1080 pixels) should be performed within one frame cycle. In cases in which there are a plurality of systems of input signals, it is difficult to simply share an image processing circuit in that manner even in the same resolution conversion process.

It is desirable to optimize the number of functional blocks which perform image processes without increasing a circuit scale.

According to an embodiment of the present disclosure, there is provided an image processing device which includes a plurality of functional blocks, a plurality of first input switching units, a second input switching unit, an output switching unit, and a selection control unit, and structures and functions of the units are as follows. Each of the plurality of functional blocks includes an input unit, an output unit, and at least one image processing circuit that performs a predetermined image process. Each of the plurality of first input switching units is associated with the input unit of each of the plurality of functional blocks one-to-one, and is configured to select one piece of image data including image data output from the output unit of another functional block and to output the selected piece of image data to the associated functional block. The second input switching unit is configured to select at least one from at least one input signals and to output the selected signal to any of the plurality of first input switching units. The output switching unit is configured to select and output at least one of signals output from the output unit of each of the functional blocks. The selection control unit is configured to control switching of selection in the first input switching units, the second input switching unit, and the output switching unit.

In addition, according to another embodiment of the present disclosure, there is provided an image processing method in which processes are performed in the following order. First, one piece of image data is selected from at least one piece of image data input to one of a plurality of functional blocks each including an input unit, an output unit, and at least one image processing circuit that performs a predetermined image process, and output. Next, image data subjected to the image process in each of the functional blocks is output, or at least one piece of image data is selected from image data output from the output unit of each of the functional blocks and output.

By configuring the image processing device as described above and performing image processes, a signal on which an image process is performed in one functional block is input to another functional block, and another image process is further performed in the functional block. Thus, by switching selection of image data in the first input switching units, the second input switching unit, and the output switching unit, a functional block in which an image process is to be performed can be appropriately selected according to the number of input signals and processing content.

According to an image processing device and an image processing method according to an embodiment of the present disclosure, the number of functional blocks which perform image processes can be optimized without increasing a circuit scale.

### BRIEF DESCRIPTION OF THE DRAWINGS

FIG. 1 is a block diagram illustrating a configuration example of an imaging device according to an embodiment of the present disclosure;

FIGS. 2A-D are descriptive diagrams showing an example of image processes to be performed within one frame cycle according to the embodiment of the present disclosure;

FIG. 3 is an illustrative diagram showing a configuration example of a functional block according to the embodiment of the present disclosure;

FIG. 4 is a block diagram illustrating a configuration example of an image processing unit according to the embodiment of the present disclosure;

FIG. 5 is an illustrative diagram showing a configuration example of selectors according to the embodiment of the present disclosure;

FIG. 6 is an illustrative diagram showing a configuration example of selectors (input switching units) according to the embodiment of the present disclosure;

FIG. 7 is an illustrative diagram showing an example of a switching process of selectors in each image process according to the embodiment of the present disclosure;

FIG. 8 is an illustrative diagram showing another example of the switching process of the selectors in each image process according to the embodiment of the present disclosure;

FIG. 9 is an illustrative diagram showing still another example of the switching process of the selectors in each image process according to the embodiment of the present disclosure;

FIG. 10 is an illustrative diagram showing the state in which a plurality of image processes are performed within the period of one frame cycle according to the embodiment of the present disclosure; and

FIG. 11 is a block diagram illustrating a configuration example of an image processing unit according to a modified example of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An example of an imaging device according to an embodiment of the present disclosure will be described in the following order with reference to the appended drawings.

1. Configuration example of an imaging device to which an image processing device of the present disclosure is applied

2. Configuration example of an image processing unit

3. Example of switching control of functional blocks in the image processing unit

4. Various modified examples

### <1. Configuration Example of an Imaging Device>

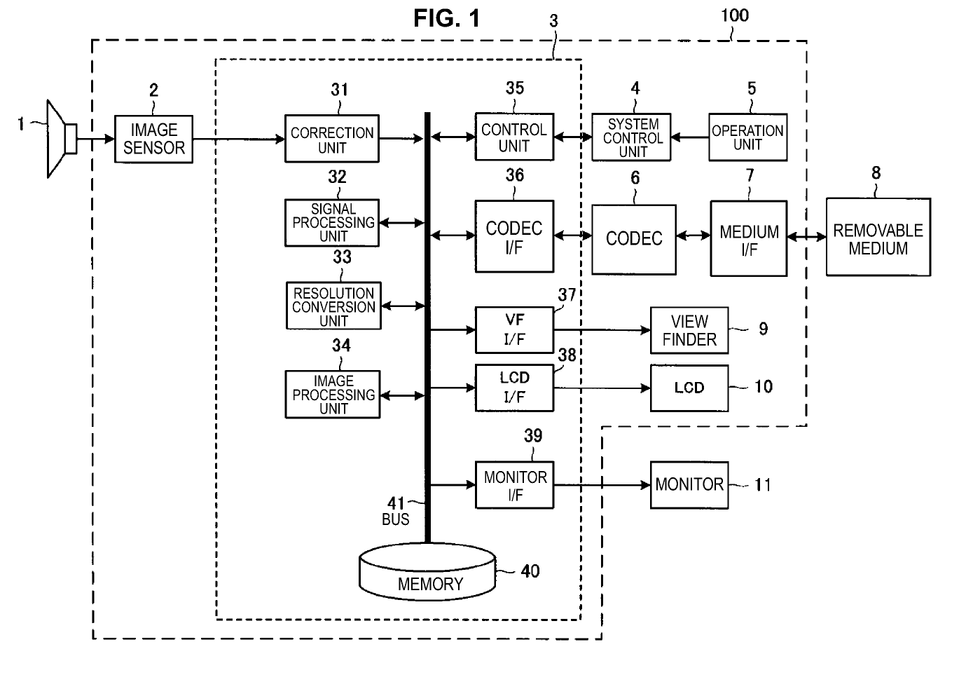

In the present embodiment, an example in which an image processing device according to an embodiment of the present disclosure is applied to an imaging device will be described. FIG. 1 is a block diagram illustrating a configuration example of the imaging device 100 according to the present embodiment. The imaging device 100 has an optical system 1 including lenses, and the like, an image sensor 2, and a signal processing circuit 3. The optical system 1 includes a shutter, an iris, and the like not illustrated in the drawing, and causes an image of subject light to be formed in an imaging region (omitted in the drawing) of the image sensor 2. The optical system 1 can be appropriately replaced according to a use environment of the imaging device 100.

The image sensor 2 photoelectrically converts the subject light which has passed through the optical system 1 and of which the image is formed in the imaging region so as to generate image signals. In the imaging region of the image sensor 2, pixels not illustrated in the drawing are disposed in a matrix shape, and in front of each pixel, color filters which are arrayed in, for example, a Bayer array are disposed. In other words, R (red), G (green), and B (blue) image signals are output from the image sensor 2. The image sensor 2 includes, for example, a CCD (Charge Coupled Device) image sensor or a CMOS (Complementary Metal Oxide Semiconductor) image sensor. In addition, resolution of the image sensor is set to be, for example, 4K.

The signal processing circuit 3 performs a predetermined signal process on the image signals obtained in the image sensor 2. Details of the signal processing circuit 3 will be described later. In addition, the imaging device 100 has a system control unit 4 and an operation unit 5. The system control unit 4 includes a CPU (Central Processing Unit), and the like, and controls each unit constituting the imaging device 100. The operation unit 5 has U/Is (User Interfaces) such as buttons, levers, and switches, and generates operation signals according to operation instructions given by a user to the U/Is and supplies the signal to the system control unit 4.

In addition, the imaging device 100 has a codec 6, a medium I/F 7, and a removable medium 8. The codec 6 performs encoding or decoding of image data. The medium I/F 7 is an interface into which the removable medium 8 is to be inserted, and performs writing processes and reading processes of image data from and to the removable medium 8. The removable medium 8 includes, for example, a memory card, and stores image data encoded by the codec 6.

In addition, the imaging device 100 has a view finder 9 and an LCD 10. The view finder 9 is configured by, for example, a liquid crystal display, and displays images captured by the image sensor 2. Display resolution of the view finder 9 is set to be, for example, VGA (Video Graphics Array), or the like. The LCD 10 is configured by, for example, a liquid crystal display, and displays setting items for photographing and images captured by the image sensor 2.

Next, details of the signal processing circuit 3 will be described also referring to FIG. 1. The signal processing circuit 3 has a correction unit 31, a signal processing unit 32, a resolution conversion unit 33, and an image processing unit 34.

The correction unit 31 performs various correction processes such as defect correction, shading correction, and a white balance process on the image signals obtained in the image sensor 2. The signal processing unit 32 performs a color separation process on the image signals corrected by the correction unit 31 so as to generate RGB signals. In addition, the signal processing unit 32 performs gamma correction, contour correction, white balance adjustment, and the like on the RGB signals so as to generate image data. In addition, the RGB signals are converted into YUV signals if necessary.

The resolution conversion unit 33 converts resolution of the image data generated by the signal processing unit 32. For example, resolution (4K) of a developed image is converted into resolution of another image size such as 2K or HD. A process of converting resolution from 4K to 2K is performed for the purpose of, for example, saving the band of a bus 41 which is a path of data exchanged between each unit of the signal processing circuit 3. Note that, in the present embodiment, although performing the process of converting the resolution of the image data obtained in the image sensor 2 from 4K to HD in the resolution conversion unit 33 is exemplified, such conversion is not limited thereto. The conversion can also be applied to a configuration in which setting can be switched between imaging with 4K and imaging with HD.

The image processing unit 34 performs various image processes on the image data generated in the signal processing unit 32 and the image data of which resolution is converted in the resolution conversion unit 33. To be specific, image processes such as a contour emphasis process, colorimetry conversion (hereinafter referred to as CLM conversion), and resolution conversion are performed.

In addition, the signal processing circuit 3 has a control unit 35, a codec I/F 36, a view finder (marked as VF in the drawing) I/F 37, an LCD I/F 38, a monitor I/F 39, and a memory 40. The control unit 35 controls each block constituting the signal processing circuit 3 based on control by the system control unit 4. The codec I/F 36 is an interface set between the codec 6 and the signal processing circuit 3, the view finder I/F 37 is an interface set between the view finder 9 and the signal processing circuit 3, and the LCD I/F 38 is an interface set between the LCD 10 and the signal processing circuit 3. The monitor I/F 39 is an interface set between the monitor 11 and the signal processing circuit 3 which is connected to the monitor 11 that can display, for example, 4K or 2K images.

The memory 40 is a frame buffer including, for example, an SDRAM (Synchronous Dynamic Random Access Memory), and the like. The memory 40 temporarily stores images which have been processed by each unit of the signal processing circuit 3. The units constituting the signal processing circuit 3 as described above are connected to each other via the bus 41.

### <2. Configuration Example of the Image Processing Unit>

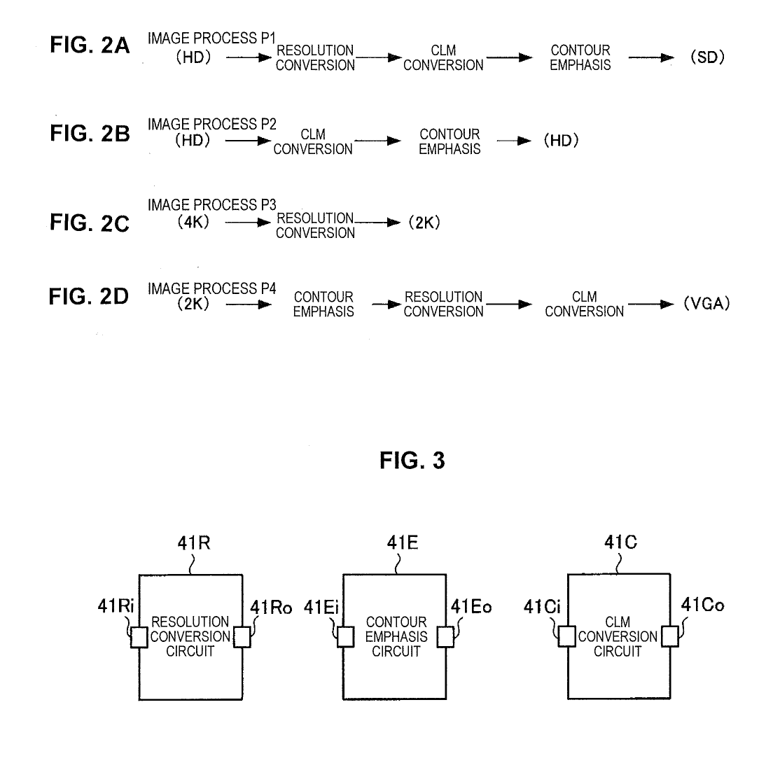

Next, details of the image processing unit 34 according to the present embodiment will be described with reference to FIGS. 2 to 7. Before a configuration example of the image processing unit 34 is described, a specific example of processes performed by the image processing unit 34 will be described with reference to FIGS. 2A-D.

It is assumed that, for example, the image processing unit 34 should perform each process shown in FIGS. 2A-D within the period of one frame cycle. An image process P1 shown in FIG. 2A is, for example, a process necessary when input image data is converted into image data to be displayed on a screen for photographed image display such as the LCD 10 (see FIG. 1). Resolution of the input image data is HD, and the resolution of the data is converted into SD and then output.

First, the resolution of the input image data is converted from HD to SD in the resolution conversion process. Next, in order to resolve a shift in chroma phases caused by performing the conversion of resolution, colorimetry conversion is performed in a CLM conversion process. Since a focusing process is performed on a screen for photographed image display, the contour emphasis process is further performed as a function of assisting focusing.

An image process P2 shown in FIG. 2B is for performing adjustment of a chroma phase and contour emphasis of the input image data. The adjustment of the chroma phase is performed in CLM conversion, and the contour emphasis is performed in the contour emphasis process. An image process P3 shown in FIG. 2C is a process of down-converting the resolution of the input image data from 4K to 2K.

An image process P4 shown in FIG. 2D is a process necessary when the input image data is converted into image data to be displayed on the screen of the view finder 9. First, the contour emphasis process is performed, and then resolution of the image data of which contour has been emphasized is converted into VGA (640×480 pixels) from 2K in the resolution conversion process. Next, a shift in chroma phases caused by the conversion of resolution is adjusted in the CLM conversion process.

In the related art, in order to complete the image processes P1 to P4 within one frame period, functional blocks obtained by combining a plurality of image processing circuits are provided to correspond to each of the image processes P1 to P4. In other words, a functional block performing the image process P1 shown in FIG. 2A is constituted by a resolution conversion circuit, a CLM conversion circuit, and a contour emphasis circuit, and a functional block performing the image process P2 shown in FIG. 2B is constituted by a CLM conversion circuit and a contour emphasis circuit. A functional block performing the image process P3 shown in FIG. 2C is only constituted by a resolution conversion circuit. A functional block performing the image process P4 shown in FIG. 2D is constituted by a contour emphasis circuit, a resolution conversion circuit, and a CLM conversion circuit. In each functional block, the image processing circuits are disposed in the order in which the processes are performed.

With the configuration as described above, the four functional blocks can be operated at the same time. By configuring a processing time of each functional block to be shorter than one frame cycle, the four image processes can be completed within the period of one frame cycle.

However, in the configuration, input and output of data on the bus occur for the functional blocks performing the image processes P1 to P4. For this reason, as the number of functional blocks increases, the frequency of input and output on the bus also increases. When a plurality of functional blocks perform a combination of image processes, it is necessary to first output image data that has been processed in a certain functional block to the bus, read the data from the bus, and then input the data to another functional block again. When such processes are performed, access to the bus is performed more frequently.

In addition, when the number of kinds of image processes to be performed within one frame cycle increases, it is necessary to also increase the number of functional blocks, and accordingly, a circuit scale expands. In addition, in the examples shown in FIGS. 2A-D, it is necessary to generate four functional blocks, but in a period in which four image processes do not have to be performed, functional blocks other than those being operated are put in an inactive state. In other words, it is difficult to say that optimization of the functional blocks is attained.

In the present embodiment, functional blocks are not provided by the number of processes to be performed within one frame cycle, but generated in units of image processing circuits to be shared for each process. The image processes P1 to P4 shown in FIGS. 2A-D are realized as a combination of the resolution conversion circuit, the contour emphasis circuit, and the CLM conversion circuit. Thus, a functional block consists of three circuits of the resolution conversion circuit, the contour emphasis circuit, and the CLM conversion circuit. The image processing circuits constituting the functional block are set to have performance capable of processing about nine images within one frame cycle.

FIG. 3 is a diagram illustrating a configuration example of image processing circuits shared for each process. Each of the image processing circuits is provided with one input unit and one output unit. A resolution conversion circuit 41R has an input unit 41Ri and an output unit 41Ro, a contour emphasis circuit 41E has an input unit 41Ei and an output unit 41Eo, and a CLM conversion circuit 41C has an input unit 41Ci and an output unit 41Co.

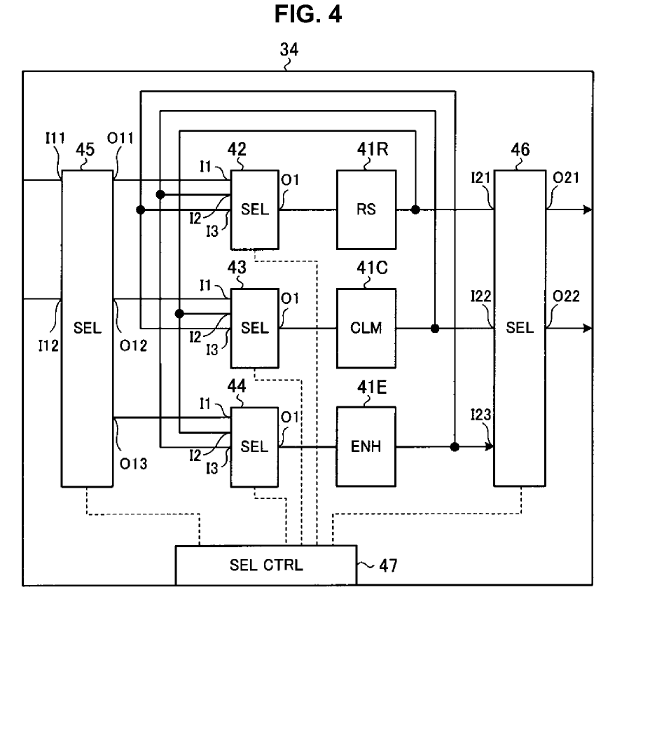

FIG. 4 is a block diagram illustrating a configuration example of the image processing unit 34 according to the present embodiment. In the example illustrated in FIG. 4, three functional blocks are provided and each of the blocks forms a “resolution conversion circuit,” a “contour emphasis circuit,” and a “CLM conversion circuit.” In FIG. 4, the “resolution conversion circuit” is indicated by “RS,” the “contour emphasis circuit” is indicated by “ENH,” and the “CLM conversion circuit” is indicated by “CLM.”

In the present embodiment, each piece of image-processed image data output from the resolution conversion circuit 41R, the CLM conversion circuit 41C, and the contour emphasis circuit 41E is configured to be used as an input value of other functional blocks. To be specific, selectors (selectors 42 to 44 to be described later) as first input switching units with respect to the resolution conversion circuit 41R, the CLM conversion circuit 41C, and the contour emphasis circuit 41E are provided, and image data output from another functional block is input to each selector.

The selector (marked as “SEL” in FIG. 4) 42 is provided for the resolution conversion circuit 41R, the selector 43 is provided for the CLM conversion circuit 41C, and the selector 44 is provided for the contour emphasis circuit 41E. Each of the selectors 42 to 44 has three input terminals I1 to I3 and one output terminal O1.

Image data selected by a selector 45 to be described later is input to the input terminal I1 of the selector 42. Image data output from the CLM conversion circuit 41C is input to the input terminal I2 of the selector 42. Image data output from the contour emphasis circuit 41E is input to the input terminal I3 of the selector 42. The selector 42 selects one of the plurality pieces of image data, and then outputs the data from the output terminal O1 to the resolution conversion circuit 41R.

Image data selected by the selector 45 to be described later is input to the input terminal I1 of the selector 43. Image data output from the resolution conversion circuit 41R is input to the input terminal I2 of the selector 43. Image data output from the contour emphasis circuit 41E is input to the input terminal I3 of the selector 43. The selector 43 selects one of the plurality pieces of image data, and then outputs the data from the output terminal O1 to the CLM conversion circuit 41C.

Image data selected by the selector 45 to be described later is input to the input terminal I1 of the selector 44. Image data output from the resolution conversion circuit 41R is input to the input terminal I2 of the selector 44. Image data output from the CLM conversion circuit 41C is input to the input terminal I3 of the selector 44. The selector 44 selects one of the plurality pieces of image data, and then outputs the data from the output terminal O1 to the contour emphasis circuit 41E.

The selector 45 is provided as a second input switching unit in the previous stage of the selectors 42, 43, and 44. The selector 45 is a unit which selects a signal input to the image processing unit 34, and has input terminals I11 and I12 and output terminals O11 to O13. Image data generated in the signal processing unit 32 and image data of which resolution is converted by the resolution conversion unit 33 are input to the input terminals I11 and I12 via the bus 41. An image signal output from the output terminal O11 is supplied to the selector 42, an image signal output from the output terminal O12 is supplied to the selector 43, and an image signal output from the output terminal O13 is supplied to the selector 44.

The selector 45 selects at least one piece of image data input to the input terminal I11 and image data input to the input terminal I12, and supplies the selected image data to at least one of the output terminals O11 to O13. Note that FIG. 4 exemplifies that image data of two systems is input to the selector 45, however, the number of systems is not limited thereto, and may be configured to be one, three, or any other number.

A selector 46 is provided as an output signal switching unit in the latter stage of the resolution conversion circuit 41R, the CLM conversion circuit 41C, and the contour emphasis circuit 41E. The selector 46 has input terminals I21 to I23 and output terminals O21 and O22. Image data output from the resolution conversion circuit 41R is input to the input terminal I21, image data output from the CLM conversion circuit 41C is input to the input terminal I22, and image data output from the contour emphasis circuit 41E is input to the input terminal I23.

The selector 46 selects at least one of image data pieces input to the input terminals, and then outputs the selected image data through the output terminal O21 or the output terminal O22. The image data output from the output terminal O21 or the output terminal O22 is transmitted via the bus 41. Note that FIG. 4 exemplifies that image data of two systems is output from the selector 46, however, the number of systems is not limited thereto, and may be configured to be one, three, or any other number.

Switching of selection in the selectors 42 to 46 is controlled by a selection control unit (marked as “SEL CTRL” in FIG. 4) 47. Control of switching by the selection control unit 47 is performed based on setting of a register set in advance.

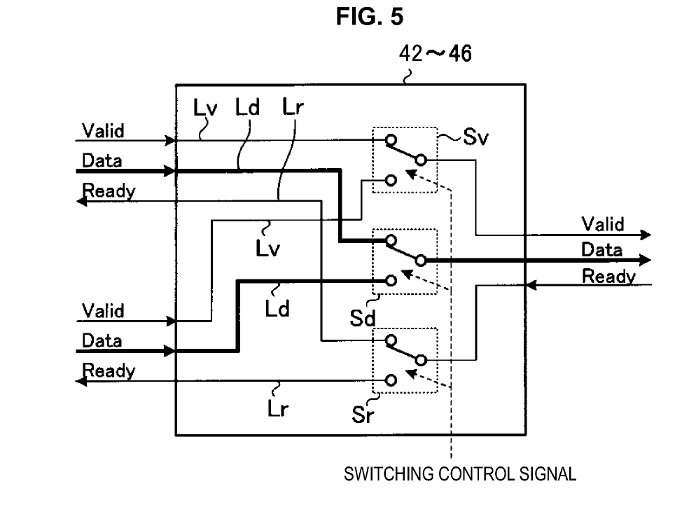

FIG. 5 is a diagram schematically illustrating a configuration of the selectors 42 to 46. For the sake of easy understanding of the description, FIG. 5 exemplifies a selector having two input systems and one output system. Signals selected by the selectors are a data line Ld, and a valid line Lv and a ready line Lr used in handshake communication.

Image data is transmitted on the data line Ld. Valid signals which indicate whether information on the data line Ld transmitted from a transmitter is valid data or invalid data are transmitted on the valid line Lv. Ready signals which indicate whether a receiver is in a receivable state or a non-receivable state are transmitted on the ready line Lr. When a valid signal indicates valid data and a ready signal indicates a receivable state, data transmission is performed.

The selectors are constituted by a switch Sv for switching the valid line Lv, a switch Sd for switching the data line Ld, and a switch Sr for switching the ready line Lr. The switches Sv, Sd, and Sr select any one of the two input systems. Switching of the switches Sv, Sd, and Sr is switched at the same time based on control by the selection control unit 47.

The selection control unit 47 transmits a switch control signal for controlling switching of the switches Sv, Sd, and Sr at a timing at which no flowing of data on the data line Ld can be confirmed. Transmission of the switch control signal to each of the switches Sv, Sd, and Sr by the selection control unit 47 is set to be performed in a shorter period than one frame cycle.

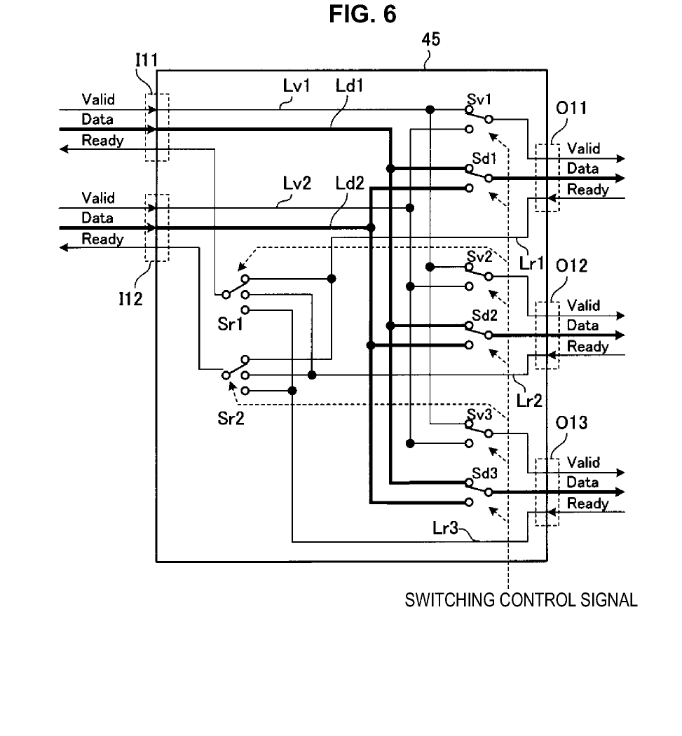

A selector such as the selector 45 serving as an input switching unit and the selector 46 serving as an output switching unit which can connect a plurality of input systems to a plurality of output systems is configured as shown in, for example, FIG. 6. FIG. 6 illustrates a configuration example of the selector 45. The selector 45 has switches Sv1 to Sv3, switches Sd1 to Sd3, and switches Sr1 and Sr2. The switch Sv1 is a switch which selects any one of the valid line Lv1 and the valid line Lv2 as a line to be connected to the output terminal O11. The valid line Lv1 is a line which transmits valid signals input from the input terminal I11, and the valid line Lv2 is a line which transmits valid signals input from the input terminal I12.

The switch Sd1 is a switch which selects any one of the data line Ld1 and the data line Ld2 as a line to be connected to the output terminal O11. The data line Ld1 is a line which transmits data signals input from the input terminal I11, and the data line Ld2 is a line which transmits data signals input from the input terminal I12.

The switch Sv2 is a switch which selects any one of the valid line Lv1 and the valid line Lv2 as a line to be connected to the output terminal O12. The switch Sd2 is a switch which selects any one of the data line Ld1 and the data line Ld2 as a line to be connected to the output terminal O12.

The switch Sv3 is a switch which selects any one of the valid line Lv1 and the valid line Lv2 as a line to be connected to the output terminal O13. The switch Sd3 is a switch which selects any one of the data line Ld1 and the data line Ld2 as a line to be connected to the output terminal O13.

The switch Sr1 is a switch which selects any one of the ready line Lr1 to the ready line Lr3 as a line to be connected to the input terminal I11. The switch Sr2 is a switch which selects any one of the ready line Lr1 to the ready line Lr3 as a line to be connected to the input terminal I12. The ready line Lr1 is a line which transmits ready signals input from the output terminal O11, and the ready line Lr2 is a line which transmits ready signals input from the output terminal O12. The ready line Lr3 is a line which transmits ready signals input from the output terminal O13.

Since input and output at each switch should be associated with each other one-to-one, it is not possible to simultaneously output, for example, a valid signal and a data signal, which have been input from the input terminal I11, from the output terminal O11 and the output terminal O12. However, different output terminals can be respectively assigned to the input terminal I11 and the input terminal I12. Thus, for example, at the same timing at which the input terminal I11 is connected to the output terminal O11, the input terminal I12 can be connected to the output terminal O12.

Even though the selector 46 is a selector having three input systems and two output systems, the configuration is the same as above. In other words, at least one of the three input systems can be selected and then connected to at least one of the two output systems. Of course, two of the three input systems can be selected, and the two selected input systems can also be connected to the two output systems.

### <3. Example of Switching Control of a Functional Block in the Image Processing Unit>

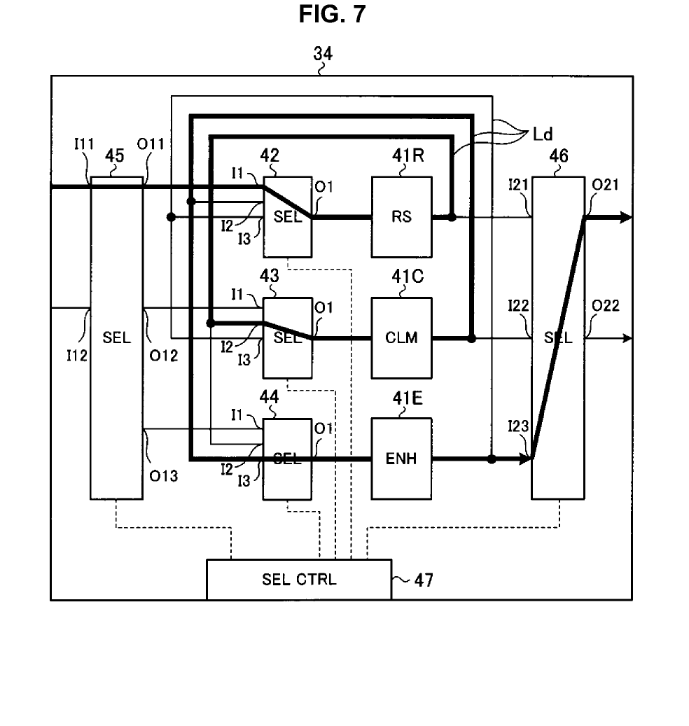

Next, an example of switching control of a functional block in the image processing unit will be described with reference to FIGS. 7 to 9. FIG. 7 is a diagram illustrating an example of switch setting of each selector when the image process P1 shown in A of FIG. 2 is performed. The image process P1 is a process in which resolution of input image data is converted from HD to SD, colorimetry conversion is performed, and then a contour emphasis process is performed.

In the example illustrated in FIG. 7, the selector 45 selects the input terminal I11 and the output terminal O11. In addition, the selector 42 selects the input terminal I1, the selector 43 selects the input terminal I2, and the selector 44 selects the input terminal I3. The selector 46 selects the input terminal I23 and the output terminal O21.

The selector 45 outputs image data having resolution of HD which has been input from the bus 41 (see FIG. 2) to the input terminal I11 through the output terminal O11. The image data output from the output terminal O11 is input to the input terminal I1 of the selector 42. The selector 42 outputs the image data input to the input terminal I1 to the output terminal O1.

The image data output from the output terminal O1 of the selector 42 is input to the resolution conversion circuit 41R. The resolution conversion circuit 41R performs a process of resizing the resolution of the image data from HD to SD. The image data resized by the resolution conversion circuit 41R is supplied to the input terminal I2 of the selector 43 through the data line Ld. Then, the selector 43 outputs the image data input from the input terminal I2 to the output terminal O1.

The image data output from the output terminal O1 of the selector 43 is input to the CLM conversion circuit 41C. The CLM conversion circuit 41C performs the colorimetry conversion. The image data of which colorimetry has been converted by the CLM conversion circuit 41C is supplied to the input terminal I3 of the selector 44 through the data line Ld. The selector 44 outputs the image data supplied from the input terminal I3 to the output terminal O1.

The image data output from the output terminal O1 of the selector 44 is input to the contour emphasis circuit 41E. The contour emphasis circuit 41E performs the contour emphasis process on the image data. The image data that has undergone the contour emphasis process by the contour emphasis circuit 41E is supplied to the input terminal I23 of the selector 46 through the data line Ld. The selector 46 outputs the image data supplied to the input terminal I23 through the output terminal O21.

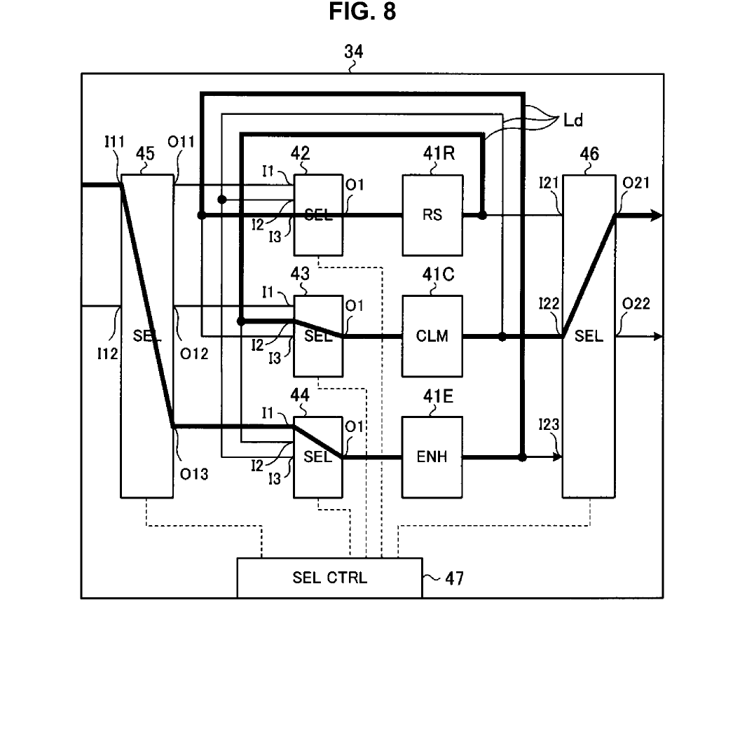

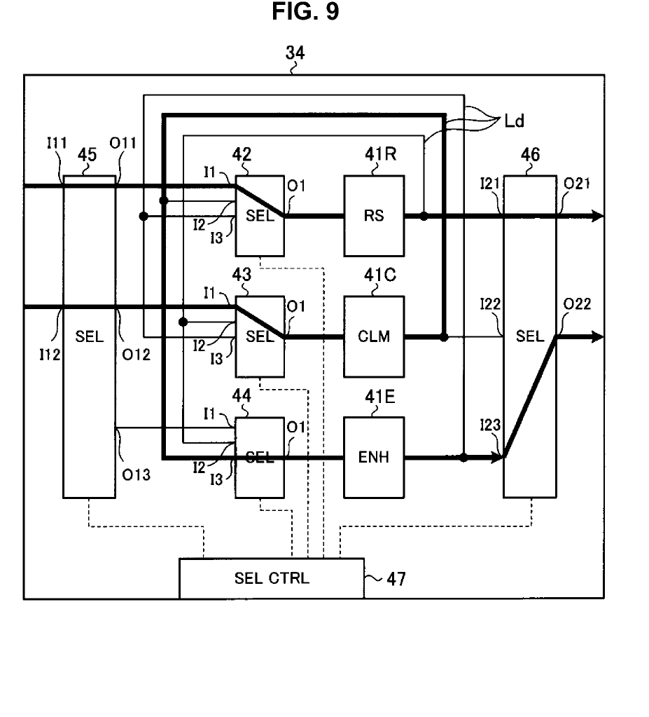

Accordingly, the image data having resolution of HD input to the input terminal I11 of the selector 45 becomes image data having resolution of SD which has undergone the colorimetry conversion as well as the contour emphasis process. After the processes are completed, selection destinations of the selectors of the image processing unit 34 are switched to the selection destinations shown in FIG. 8 based on control of the selection control unit 47. The completion of the image process is confirmed at the time when there is no image data output from the output terminal O21 of the selector 46 as an output signal switching unit and transmitted on the data line Ld.

FIG. 8 is a diagram illustrating an example of selection setting of the selectors when the image process P4 shown in D of FIG. 2 is performed. The image process P4 is a process in which the contour emphasis process is performed on input image data, then resolution thereof is converted from 2K to VGA, and colorimetry conversion is further performed thereon.

In the example illustrated in FIG. 8, the selector 45 selects the input terminal I11, and the output terminal O13. In addition, the selector 42 selects the input terminal I3, the selector 43 selects the input terminal I2, and the selector 44 selects the input terminal IL The selector 46 selects the input terminal I22 and the output terminal O21.

The selector 45 outputs the image data having resolution of 2K input to the input terminal I11 from the bus 41 through the output terminal O13. The image data output through the output terminal O13 is input to the input terminal I1 of the selector 44. The selector 44 outputs the image data input to the input terminal I1 through the output terminal O1.

The image data output through the output terminal O1 of the selector 44 is input to the contour emphasis circuit 41E. The contour emphasis circuit 41E performs the contour emphasis process on the image data. The image data which has undergone the contour emphasis process by the contour emphasis circuit 41E is input to the input terminal I3 of the selector 42 through the data line Ld. The selector 42 outputs the image data input to the input terminal I3 through the output terminal O1.

The image data output through the output terminal O1 of the selector 42 is input to the resolution conversion circuit 41R. The resolution conversion circuit 41R performs a process to resize the resolution of the image data from 2K to VGA. The image data of which the resolution has been resized by the resolution conversion circuit 41R is input to the input terminal I2 of the selector 43 through the data line Ld. The selector 43 outputs the image data input to the input terminal I2 through the output terminal O1.

The image data output through the output terminal O1 of the selector 43 is input to the CLM conversion circuit 41R. The image data which has undergone colorimetry conversion by the CLM conversion circuit 41R is supplied to the input terminal I22 of the selector 46. The selector 46 outputs the image data input to the input terminal I22 through the output terminal O21.

Accordingly, the image data having resolution of 2K input to the input terminal I11 of the selector 45 becomes image data which has first undergone the contour emphasis process, resolution of which has then been converted to VGA, and which finally has undergone colorimetry conversion. After the processes are completed, the selection destinations of the selectors of the image processing unit 34 are switched to selection destinations shown in FIG. 9.

FIG. 9 is a diagram illustrating selection examples of the selectors when the image process P2 shown in B of FIG. 2 and the image process P3 shown in C of FIG. 2 are performed. The image process P2 is a process of performing the contour emphasis process on input image data after performing colorimetry conversion thereon. Resolution of the input image data here is set to be, for example, HD. The image process P3 is a process of down-converting resolution of image data from 4K to 2K. Since image processing circuits to be used do not overlap in the image process P2 and the image process P3, the image process P2 and the image process P3 can be performed in parallel.

In the example illustrated in FIG. 9, the selector 45 selects the input terminal I11 and the input terminal I12, and selects the output terminal O11 and the output terminal O12. Image data having resolution of 4K which is subject to the image process P2 is input to the input terminal I11 of the selector 45. Image data having resolution of HD which is subject to the image process P3 is input to the input terminal I12 of the selector 45.

The selector 42 selects the input terminal I1, the selector 43 selects the other input terminal I1, and the selector 44 selects the input terminal I3. The selector 46 selects the input terminal I21 and the input terminal I23, and the output terminal O21 and the output terminal O22.

The selector 45 outputs the image data having resolution of 4K input to the input terminal I11 from the bus 41 through the output terminal O11. The image data output through the output terminal O11 is input to the input terminal I1 of the selector 42. The selector 42 outputs the image data input to the input terminal I1 through the output terminal O1.

The image data output through the output terminal O1 of the selector 42 is input to the resolution conversion circuit 41R. The resolution conversion circuit 41R performs a process to resize the resolution of the image data from 4K to 2K. The image data of which the resolution has been resized by the resolution conversion circuit 41R is input to the input terminal I21 of the selector 46. The selector 46 outputs the image data input to the input terminal I21 through the output terminal O21.

In addition, the selector 45 outputs the image data having resolution of HD input to the input terminal I12 through the output terminal O12. The image data output through the output terminal O12 is input to the input terminal I1 of the selector 43. The selector 43 outputs the image data input to the input terminal I1 through the output terminal O1.

The image data output through the output terminal O1 of the selector 43 is input to the CLM conversion circuit 41C. The CLM conversion circuit 41C performs colorimetry conversion. The image data which has undergone the colorimetry conversion by the CLM conversion circuit 41C is supplied to the input terminal I3 of the selector 44 through the data line Ld. The selector 44 outputs the image data supplied to the input terminal I3 through the output terminal O1.

The image data output through the output terminal O1 of the selector 44 is input to the contour emphasis circuit 41E. The contour emphasis circuit 41E performs the contour emphasis process on the image data. The image data which has undergone the contour emphasis process by the contour emphasis circuit 41E is input to the input terminal I23 of the selector 46. The selector 46 outputs the image data input to the input terminal I23 through the output terminal O22.

Accordingly, the image data having resolution of 4K input to the input terminal I11 of the selector 45 is converted into image data having resolution of 2K. At the same time, the image data having resolution of HD input to the input terminal I12 of the selector 45 is output as image data which has undergone colorimetry conversion, and further undergone the contour emphasis process.

As described above, the resolution conversion circuit 41R, the CLM conversion circuit 41C, and the contour emphasis circuit 41E are each capable of processing about nine images in one frame cycle. Since three respective images are generated in the image process P1 illustrated in FIG. 7 and the image process P4 illustrated in FIG. 8, the processing time can be calculated to be about ⅓ of a frame. In the example illustrated in FIG. 9, one image is generated in the image process P2, and two images are generated in the image process P3. Since the image process P2 and the image process P3 are performed in parallel, the processing time of the phase shown in FIG. 9 is the time in which two images are generated to the maximum. In other words, the processing time is less than ⅓ of a frame.

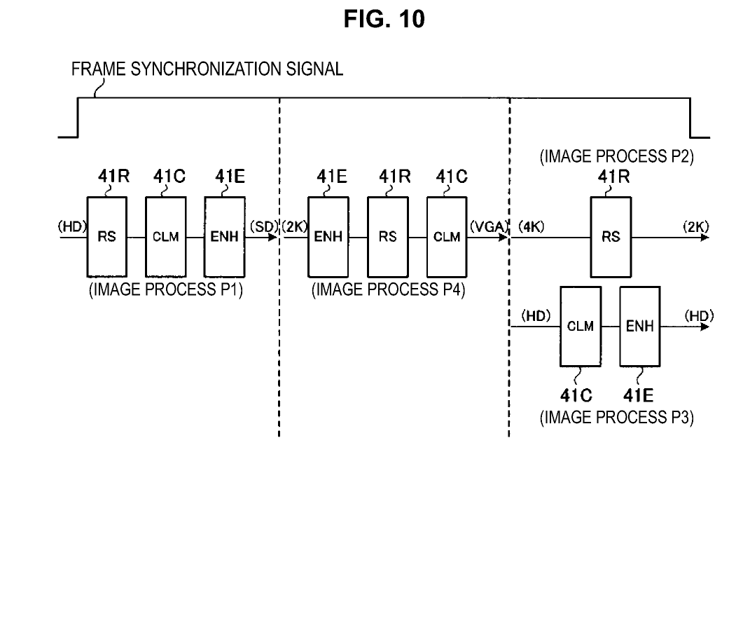

FIG. 10 illustrates arrangement of processes illustrated in FIGS. 7 to 9 in the time direction. The image process P1 is performed by setting the selectors of the image processing unit 34 to be in the selection setting as illustrated in FIG. 7. In other words, the process is performed in order of the resolution conversion circuit 41R, the CLM conversion circuit 41C, and the contour emphasis circuit 41E. Next, by switching the selectors to be in the selection setting as illustrated in FIG. 8, the image process P4 is performed. In other words, the process is performed in order of the contour emphasis circuit 41E, the resolution conversion circuit 41R, and the CLM conversion circuit 41C. Then, by switching the selectors to be in the selection setting illustrated in FIG. 9, the image process P2 and the image process P3 are performed. In other words, the image process P2 using the resolution conversion circuit 41R and the image process P3 performed using the CLM conversion circuit 41C and the contour emphasis circuit 41E in order are performed in parallel.

The processing times in the image process P1, the image process P4, and the image process P2 and in the image process P3 are within the time of ⅓ frame cycle. Therefore, all processes of the image process P1, the image process P4, and the image process P2 and the image process P3 are completed within the period of one cycle of a frame synchronization signal.

According to the present embodiment, image data which has undergone an image process in one functional block which includes at least one image processing circuit can also be used as input of another functional block. Selection of image data input to a functional block is performed by selectors provided corresponding to respective functional blocks. Accordingly, the order in which processes are performed in the functional blocks can be freely rearranged.

In addition, by providing the selector 45 which switches image data input to the image processing unit 34 and the selector 46 which switches image data output from the image processing unit 34, the number of input and output systems of a signal to and from the image processing unit 34 can be arbitrarily set.

As described above, since the order in which processes are performed in each functional block and the number of input and output systems of a signal to and from the image processing unit 34 is freely changed, various kinds of image processes can be performed with a small number of functional blocks by performing switching of the selectors in a time-sharing manner.

In addition, as the processes are performed in a time-sharing manner, even when there are a plurality of kinds of image processes for which the same image processing circuit should be used, the image processes will not performed at the same time. Thus, image processing circuits to be prepared as functional blocks can be configured only by circuits shared so as to be used in a plurality of image processes to be performed within one frame period. While there are four image processes to be performed within one frame period in the embodiment described above, the number of functional blocks may only be three of the resolution conversion circuit 41R, the CLM conversion circuit 41C, and the contour emphasis circuit 41E. In other words, a circuit scale can be reduced.

In addition, image data selected by the selector 45 is input to each of the functional blocks, and the image data output from each of the functional blocks is output via the selector 46. Accordingly, even when processes in the functional blocks are combined, the amount of signals input and output with respect to the bus 41 does not increase. In the present embodiment, data transmitted through the bus 41 is only image data which is input to the selector 45 and is subject to the image process P1, and data which has undergone the image process P2 or the image process P3 and is output from the selector 46. In other words, according to the present embodiment, the number of times of and the amount of data flowing on the bus 41 can be reduced.

In addition, according to the embodiment described above, since a plurality of image processes can be performed in a time-sharing manner, by using image processing circuits which have a high processing speed to perform switching of each selector at a high speed, the plurality of image processes can be performed within the period of one frame cycle.

In addition, according to the embodiment described above, transmission and reception of image data are performed based on a standard procedure of handshake, and switching of each selector is also performed based on handshake communication. Ultimately, a system can be easily constructed using an existing structure without providing an independent structure, procedure, or the like.

### <4. Various Modified Examples>

Note that, although the embodiment described above exemplifies that the plurality of image processes are performed within the period of one frame cycle, it is not limited thereto. A unit processing time in which a plurality of image processes are performed is not limited to one frame, and may be the time of two frames or more.

In addition, although the embodiment described above exemplifies that the functional blocks are constituted by the resolution conversion circuit 41R, the CLM conversion circuit 41C, and the contour emphasis circuit 41E, circuits are not limited thereto. Functional blocks may be constituted by other image processing circuits such as a color conversion circuit and an affine transformation circuit.

In addition, although the embodiment described above exemplifies that three functional blocks are provided, the number of blocks is not limited thereto. The number may be another number such as four or five so long as the number satisfies the condition that image processes are completed within a predetermined unit processing time in a time-sharing manner.

In addition, although the embodiment described above exemplifies that a functional block includes one image processing circuit, the number of circuits is not limited thereto. A functional block may include a plurality of image processing circuits.

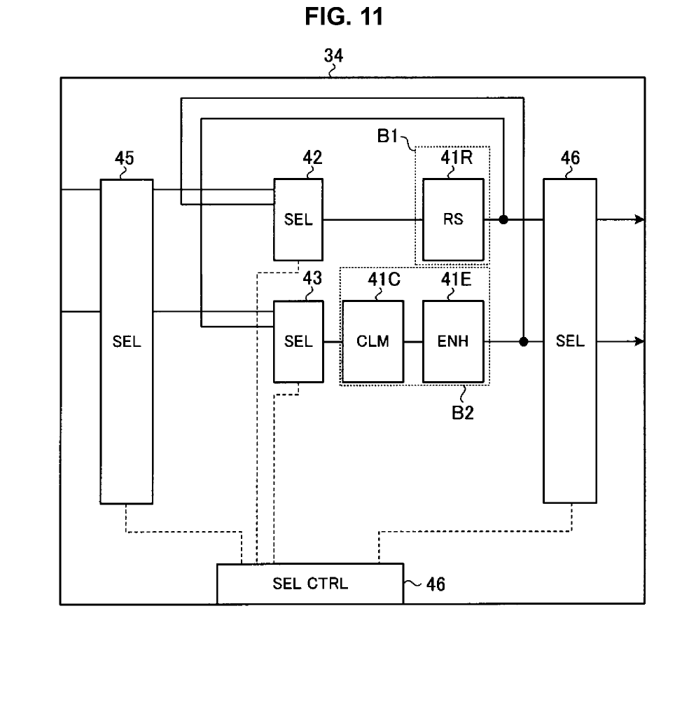

FIG. 11 is a diagram illustrating a configuration example when one functional block includes two image processing circuits. In FIG. 11, the same reference numerals are given to portions corresponding to FIGS. 4 and 7 to 9, and overlapping description thereof is omitted. The image processing unit 34 illustrated in FIG. 11 has two functional blocks. One is a functional block B1 which includes the resolution conversion circuit 41R, and the other is a functional block B2 which includes the CLM conversion circuit 41C and the contour emphasis circuit 41E. In the functional block B2, the CLM conversion circuit 41C is connected to the contour emphasis circuit 41E in series. In other words, in the functional block B2, both processes of the CLM conversion process and the contour emphasis process are performed in order of the CLM conversion process and the contour emphasis process. When the order of the image processes is fixed as above, the functional block may be configured such that a plurality of image processing circuits therein are connected to each other in series.

In addition, although the embodiment described above exemplifies that transmission and reception of image data are performed using valid-ready-type handshake communication, it is not limited thereto. Transmission and reception of image data may be performed using another scheme such as valid-ack-type handshake communication.

In addition, although the embodiment described above exemplifies that the selectors perform switching at a timing at which no data transmission on the data line Vd can be confirmed based on signals exchanged in handshake communication, it is not limited thereto. A time to process each functional block is computed in advance based on a processing speed of each image processing circuit, and when the time comes, the selectors may be switched.

In addition, although the embodiment described above exemplifies that the image processing device according to an embodiment of the present disclosure is applied to an imaging device having an image sensor, it is not limited thereto. The image processing device according to an embodiment of the present disclosure may be applied to other image processing devices such as a reproduction device so long as it is a device which should perform a plurality of image processes within a predetermined unit processing time. When the image processing device according to an embodiment of the present disclosure is applied to a reproduction device, for example, an image to be displayed on a display device having high resolution and an image to be transferred to another device using a communication section can also be generated within a predetermined unit processing time.

Additionally, the present technology may also be configured as below.

(1)
An image processing device including:

a plurality of functional blocks each including,
an input unit,
an output unit, and
at least one image processing circuit that performs a predetermined image process;

a plurality of first input switching units each being associated with the input unit of each of the plurality of functional blocks one-to-one, and each being configured to select one piece of image data including image data output from the output unit of another functional block and to output the selected piece of image data to the associated functional block;

a second input switching unit configured to select at least one piece of image data from at least one piece of input image data and to output the selected at least one piece of image data to any of the plurality of first input switching units;

an output switching unit configured to select and output at least one piece of image data from the image data output from the output unit of each of the functional blocks; and

a selection control unit configured to control switching of selection in the first input switching units, the second input switching unit, and the output switching unit.

(2)
The image processing device according to (1), wherein the first input switching units, the second input switching unit, and the output switching unit are configured as selectors.
   (3)
The image processing device according to (1) or (2), wherein the image process is performed in each of the functional blocks in a time-sharing manner.
   (4)
The image processing device according to (3), wherein the image process performed in each of the functional blocks in the time-sharing manner is performed within a predetermined unit processing time.
   (5)
The image processing device according to any one of (1) to (4), wherein the predetermined unit processing time is one frame in terms of a frame rate of imaging.
   (6)
The image processing device according to any one of (1) to (5),

wherein lines connecting the first input switching units, the second input switching unit, and the output switching unit to one another include a data line and a handshake line, and

wherein switching of selection destinations in the first input switching units, the second input switching unit, and the output switching unit by the selection control unit is performed at a timing at which no signals flowing on the data line are detected based on handshake communication.

(7)
The image processing device according to (6), wherein the handshake line includes a transmission line of a valid signal and a transmission line of a ready signal.
   (8)
The image processing device according to any one of (1) to (5), wherein switching of selection destinations in the first input switching units, the second input switching unit, and the output switching unit by the selection control unit is performed at timings calculated based on times of the image processes performed in the functional blocks.
   (9)
An image processing method including:

selecting and outputting one piece of image data from at least one piece of image data input to one of a plurality of functional blocks each including an input unit, an output unit, and at least one image processing circuit that performs a predetermined image process; and

outputting image data subjected to the image process in each of the functional blocks or selecting and outputting at least one piece of image data from image data output from the output unit of each of the functional blocks.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a plurality of functional blocks each including,
an input unit,
an output unit, and
at least one image processing circuit that performs a predetermined image process;
a plurality of first input switching units each being associated with the input unit of each of the plurality of functional blocks one-to-one, and each being configured to select one piece of image data including image data output from the output unit of another functional block and to output the selected piece of image data to the associated functional block;
a second input switching unit configured to select at least one piece of image data from at least one piece of input image data and to output the selected at least one piece of image data to any of the plurality of first input switching units;
an output switching unit configured to select and output at least one piece of image data from the image data output from the output unit of each of the functional blocks; and
a selection control unit configured to control switching of selection in the first input switching units, the second input switching unit, and the output switching unit.

2. The image processing device according to claim 1, wherein the first input switching units, the second input switching unit, and the output switching unit are configured as selectors.

3. The image processing device according to claim 2, wherein the image process is performed in each of the functional blocks in a time-sharing manner.

4. The image processing device according to claim 3, wherein the image process performed in each of the functional blocks in the time-sharing manner is performed within a predetermined unit processing time.

5. The image processing device according to claim 4, wherein the predetermined unit processing time is one frame in terms of a frame rate of imaging.

6. The image processing device according to claim 5,
wherein lines connecting the first input switching units, the second input switching unit, and the output switching unit to one another include a data line and a handshake line, and
wherein switching of selection destinations in the first input switching units, the second input switching unit, and the output switching unit by the selection control unit is performed at a timing at which no signals flowing on the data line are detected based on handshake communication.

7. The image processing device according to claim 6, wherein the handshake line includes a transmission line of a valid signal and a transmission line of a ready signal.

8. The image processing device according to claim 5, wherein switching of selection destinations in the first input switching units, the second input switching unit, and the output switching unit by the selection control unit is performed at timings calculated based on times of the image processes performed in the functional blocks.

9. An image processing method comprising:
selecting and outputting one piece of image data from at least one piece of image data input to one of a plurality of functional blocks each including an input unit, an output unit, and at least one image processing circuit that performs a predetermined image process; and
outputting image data subjected to the image process in each of the functional blocks or selecting and outputting at least one piece of image data from image data output from the output unit of each of the functional blocks.
